(19) United States
(12) Patent Application Publication
(10) Pub. No.: US 2023/0223815 A1
(43) Pub. Date: Jul. 13, 2023

(54) Cycloidal speed reducer

(71) Applicant: Ace Machine Design LLC, Los Angeles, CA (US)

(72) Inventor: Agustus Berman Shelander, Los Angeles, CA (US)

(21) Appl. No.: 17/803,747

(22) Filed: Nov. 5, 2022

Related U.S. Application Data
(60) Provisional application No. 63/276,087, filed on Nov. 5, 2021.

(51) Int. Cl. H02K 7/10

(52) U.S. Cl. CPC H02K 7/10

(57) ABSTRACT

A cycloidal speed reducer including a housing for input and output rotor assemblies. Stationary pin features having a radius are spaced in a housing cavity. The input assembly includes an eccentric hub with an eccentricity equal or greater than the radius, two lobes each rotatably holding a cycloid disk, and an input engagement feature for a drive motor. The cycloid disks each have engagement holes and contact surfaces having truncated-profiles. The output assembly includes a pin disc holding roller pins, and an output engagement feature for a driven device. As rotational motion is input to the cycloidal speed reducer from the drive motor, the input rotor assembly and cycloid disks are rotated, the contact surfaces interact with the stationary pin features, the engagement holes of the cycloid disks interact with the roller pins and the output assembly is rotated, and proportional rotational motion is output to the driven device.

### CROSS-REFERENCE TO RELATED APPLICATIONS

This application claims the benefit of U.S. Provisional Application No. 63/276,087, filed Nov. 5, 2021, hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

### Technical Field

The present invention relates generally to gearing, and more particularly to cycloidal speed reducers.

### Background Art

A cycloidal drive or cycloidal speed reducer is a mechanism for reducing the speed of an input shaft by a set ratio. In particular, cycloidal speed reducers are usefully capable of relatively high speed reduction ratios and compact sizes.

FIG. 1 (Prior Art) stylistically depicts the major elements and their interactions in a conventional cycloidal speed reducer 1. A clockwise rotated eccentric shaft 2 (i.e., an input drive shaft) provides input to the conventional cycloidal speed reducer 1 shown here. The eccentric shaft 2 movingly engages with a cycloidal disc 3 that includes a set of holes 4. This movingly rotates the cycloidal disc 3 around its own axis of symmetry within a set of fixed ring pins 5 that are arranged in a circle (a ring) around the eccentric shaft 2. Concurrently, a set of roller pins 6 on a pin disc 7 engage in the holes 4 in the cycloidal disc 3 as it rotates. In this manner, the motion of the cycloidal disc 3 rotationally drives the pin disc 7 counter-clockwise, and an attached centrally mounted output shaft 8 is thus also rotated counter-clockwise.

In addition to the reversal in the direction of rotation, from a clockwise input to a counter-clockwise output here, there is also a substantial speed reduction since the output shaft 8 is rotated only 40° during each complete rotation of 360° of the eccentric shaft 2, thus accomplishing a 9:1 transmission ratio.

FIG. 2a-b (Prior Art) show selected elements of the conventional cycloidal speed reducer 1 in FIG. 1. FIG. 2a has the eccentric shaft 2 and the cycloidal disc 3 removed to emphasize the relationships of the set of fixed ring pins 5, the pin disc 7 and its set of roller pins 6, and how these all relate to a common axis 9 (which is also the axis of symmetry of the cycloidal disc 3). FIG. 2b shows only the eccentric shaft 2 assembly and how it overall shares the same common axis 9.

[As this is being written, a description and an excellent animated depiction exist at www.tec-science.com/mechanical-power-transmission/planetary-gear/how-does-a-cycloidal-gear-drive-work.]

### BRIEF SUMMARY OF THE INVENTION

Accordingly, it is an object of the present invention to provide an improved cycloidal speed reducer.

Briefly, one preferred embodiment of the present invention is a cycloidal speed reducer to mate between a drive motor and an opposed driven device along an axis of symmetry. The housing has a generally cylindrical shaped interior cavity containing an input and output rotor assemblies. A set of stationary pin features a having radius are spaced equidistant around the interior cavity equidistant from the axis of symmetry. The input rotor assembly includes an eccentric hub having an eccentricity equal to or greater than the radius, a pair of lobes each rotatably holding a cycloid disk, and also has an input engagement feature to engage with a drive motor. The cycloid disks each have a set of engagement holes and a set of contact surfaces having truncated-profiles. The output rotor assembly includes a pin disc holding a set of roller pins, and also has an output engagement feature to engage with a driven device. As an input rotational motion is input to the cycloidal speed reducer from the drive motor, the input rotor assembly and the cycloid disks are rotated, the contact surfaces interact with the stationary pin features, the engagement holes of the cycloid disks interact with the roller pins of the output rotor assembly to rotate it, and an output rotational motion proportional to the input rotational motion is output to the driven device.

Briefly, another preferred embodiment of the present invention is a cycloidal speed reducer to mate between a drive motor and an opposed driven device along an axis of symmetry. The housing has a generally cylindrical shaped interior cavity containing an input and output rotor assemblies. A set of stationary pin features are spaced equidistant around the interior cavity equidistant from the axis of symmetry. The input rotor assembly includes an eccentric hub having a pair of lobes each rotatably holding a cycloid disk, and also has an input engagement feature that is a female-like void suitable for accepting a male-like shaft of the drive motor. The cycloid disks each have a set of engagement holes and a set of contact surfaces. The output rotor assembly includes a pin disc holding a set of roller pins, and also has an output engagement feature that is a female-like void suitable for accepting a male-like shaft of the driven device. As an input rotational motion is input to the cycloidal speed reducer from the drive motor, the input rotor assembly and the cycloid disks are rotated, the contact surfaces interact with the stationary pin features, the engagement holes of the cycloid disks interact with the roller pins of the output rotor assembly to rotate it, and an output rotational motion proportional to the input rotational motion is output to the driven device.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 (Prior Art) stylistically depicts the major elements and their interactions of a conventional cycloidal speed reducer;

FIG. 2a-b (Prior Art) show selected elements of the conventional cycloidal speed reducer in FIG. 1, wherein FIG. 2a has the eccentric shaft and the cycloidal disc removed to emphasize the relationships of the set of fixed ring pins, the pin disc and its set of roller pins, and how these all relate to a common axis, and wherein FIG. 2b shows only the eccentric shaft assembly and how this overall shares the same common axis;

FIG. 3 is an exploded view of an application employing a cycloidal speed reducer in accord with the present invention;

FIG. 4 is a perspective view of just the cycloidal speed reducer in FIG. 3;

FIG. 5a-d are straight forward plane views of the cycloidal speed reducer in FIGS. 3 & 4, wherein FIG. 5a depicts a top view (with the bottom aspect simply mirroring this), FIG. 5b depicts a front view, FIG. 5c depicts a right side view (with the left aspect simply mirroring this), and FIG. 5d depicts a back view;

FIG. 6 is front view of the housing of one preferred embodiment of the cycloidal speed reducer with the input rotor assembly and the output rotor assembly removed to emphasize optional features;

FIG. 7 is an exploded view of portions of the input rotor assembly in FIG. 3;

FIG. 8 is a cross-sectional side plane view of the cycloidal speed reducer taken along section A-A in FIG. 5b;

FIGS. 9a-c show portions of FIG. 8, wherein FIG. 9a shows just the housing, FIG. 9b shows just the input rotor assembly, and FIG. 9c shows just the output rotor assembly; and

FIG. 10 is a highly stylized cross-sectional front plane view of the cycloidal speed reducer taken along section B-B in FIG. 5c, wherein particular details of the stationary pin features and of the cycloid disks are visible.

In the various figures of the drawings, like references are used to denote like or similar elements or steps.

### DETAILED DESCRIPTION OF THE INVENTION

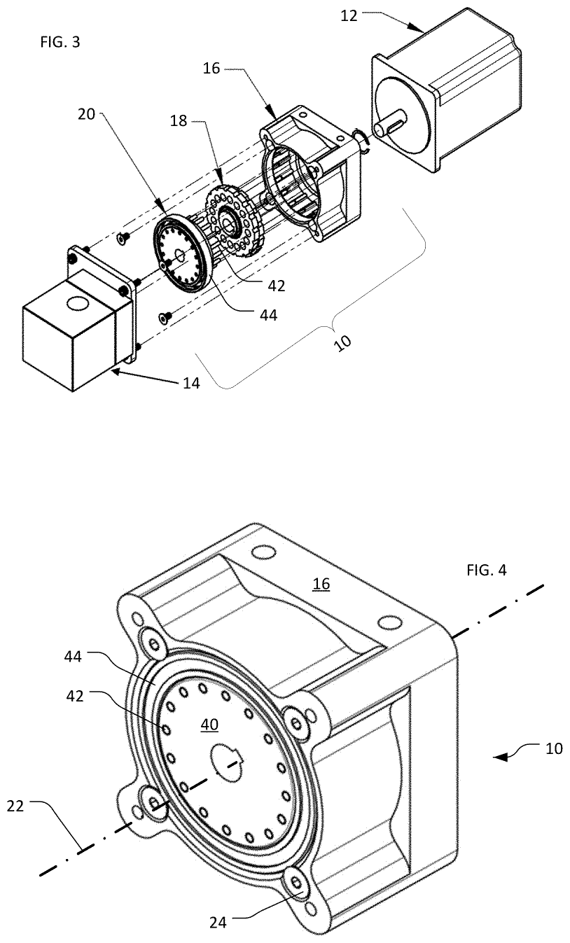

A preferred embodiment of the present invention is a cycloidal speed reducer. As illustrated in the various drawings herein, and particularly in the view of FIG. 3, embodiment(s) of the invention are depicted by the general reference character 10.

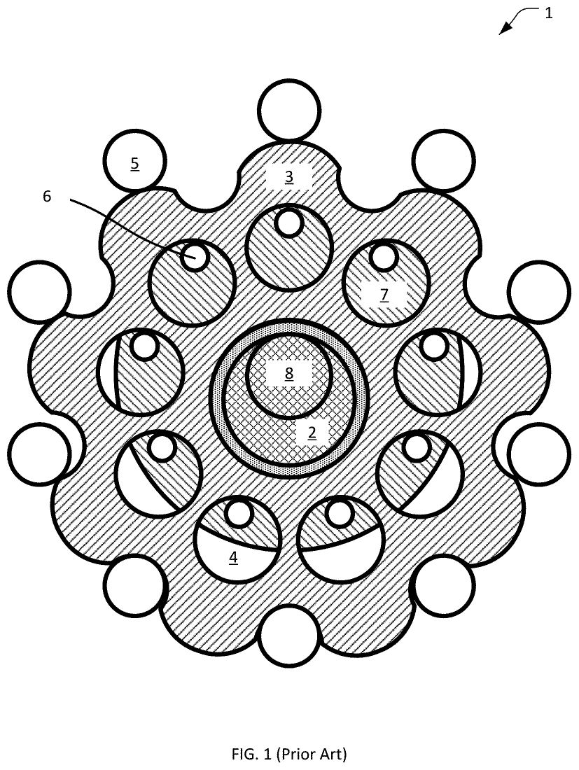

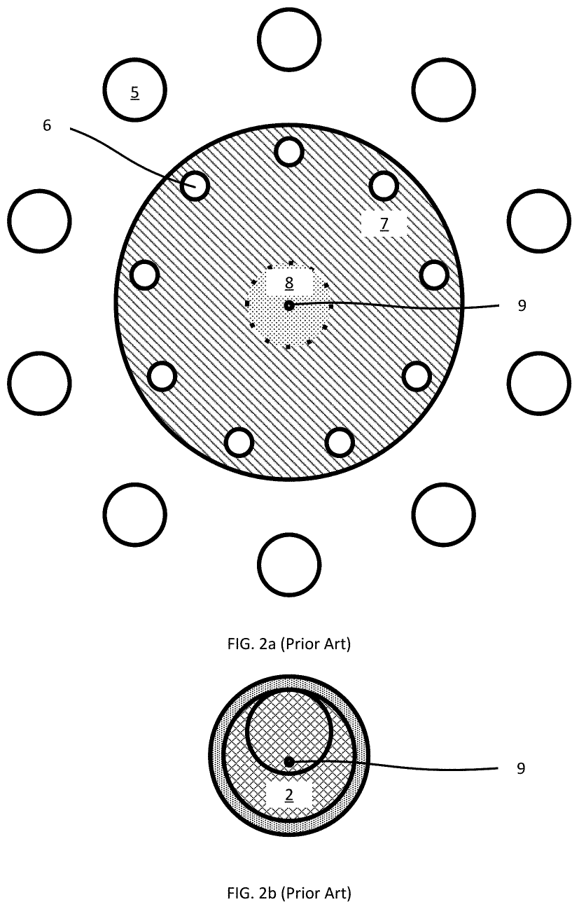

FIG. 3 is an exploded view of an application employing an inventive cycloidal speed reducer 10. Proceeding from top right to lower left, from input to output, the application depicted here includes a drive motor 12, the cycloidal speed reducer 10, and a driven device 14. The cycloidal speed reducer 10, again proceeding from top right to lower left, can be seen to have a housing 16, an input rotor assembly 18, and an output rotor assembly 20. [It should be noted that while the conventional cycloidal speed reducer 1 shown in FIGS. 1 and 2a-b (Prior Art) has its input driven from the front and its output drives out the back, the cycloidal speed reducer 10 here has its input driven from the back and its output drives out the front (i.e., opposite).]

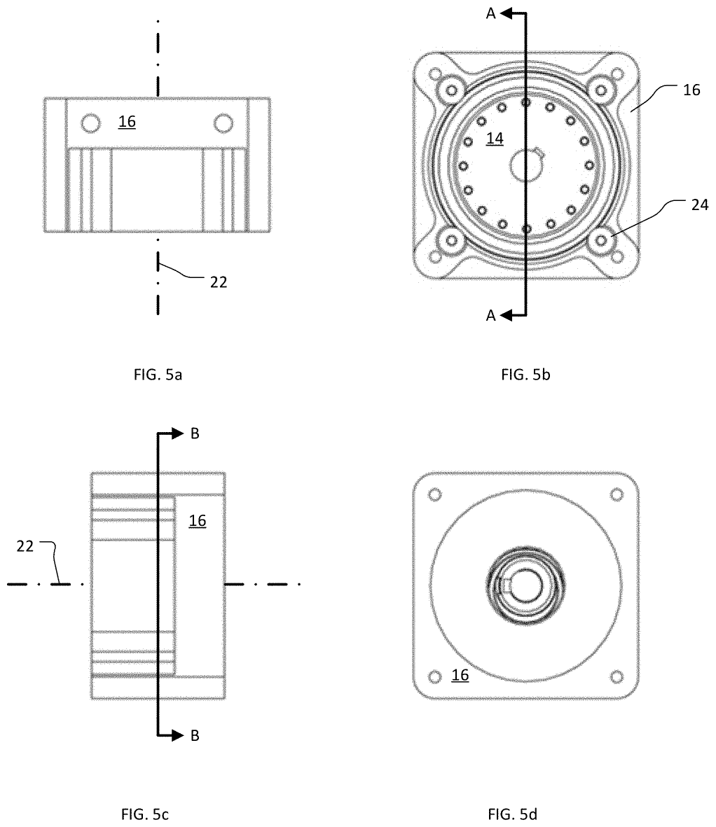

FIG. 4 is a perspective view of just the cycloidal speed reducer 10. Here it can be seen that the cycloidal speed reducer 10 has an overall central axis of symmetry 22. The axis of symmetry 22 will be coaxial with the input from the drive motor 12 and the output to the driven device 14, but not necessarily in all embodiments coaxial with the housing 16. That is, alternate housings housings can be used as long as the functional internal elements of the cycloidal speed reducer 10 are maintained in their herein described functional relationships with the axis of symmetry 22. A set of retaining screws 24 holds the output rotor assembly 20 in place in the cycloidal speed reducer 10, in straightforward manner.

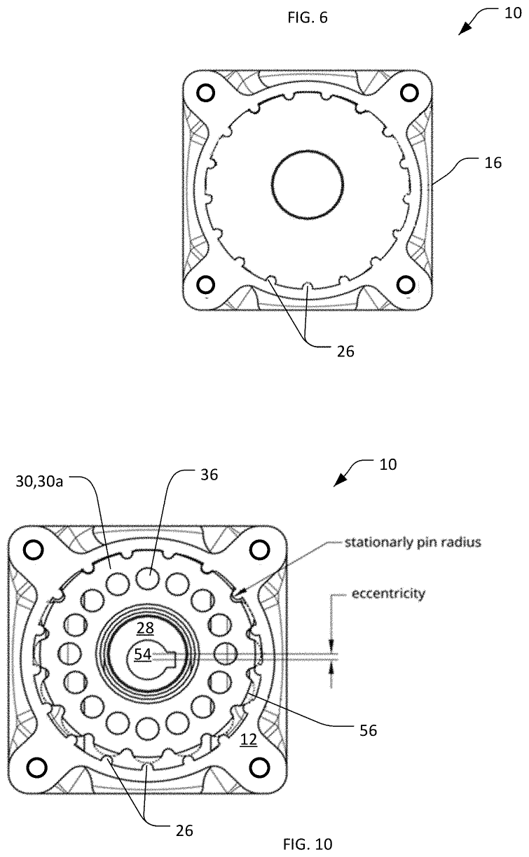

FIG. 5a-d are straight forward plane views of the cycloidal speed reducer 10 in FIGS. 3 & 4. FIG. 5a depicts a top view (with the bottom aspect simply mirroring this). FIG. 5b depicts a front view. FIG. 5c depicts a right side view (with the left aspect simply mirroring this). And FIG. 5d depicts a back view.

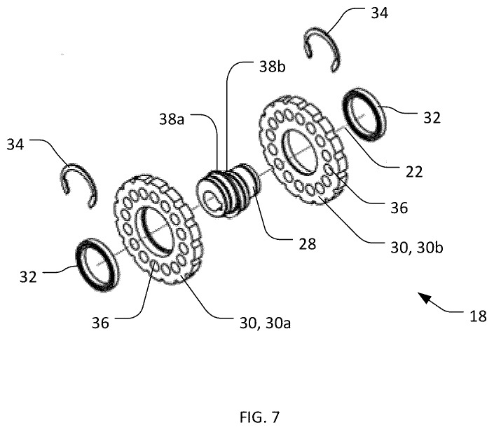

FIG. 6 is front view of the housing 16 of one preferred embodiment of the cycloidal speed reducer 10 with the input rotor assembly 18 and the output rotor assembly 20 removed to emphasize optional features. With reference also to FIGS. 1 and 2a (Prior Art), it can be seen that the fixed ring pins 5 of the conventional prior art cycloidal speed reducer 1 here are full pins (i.e., round). Additionally, unshown in FIGS. 1 and 2a, is that such fixed ring pins are usually discrete from the housing in conventional prior art cycloidal speed reducers. In contrast, in the embodiment of the inventive cycloidal speed reducer 10 in FIG. 6 the fixed pin-like elements can be stationary pin features 26 which are optionally partly rounded only at their contact surfaces with elements of the input rotor assembly 18 (discussed further presently). Moreover, these stationary pin features 26 can be integral with the housing 16 (as also shown; benefits of these optional arrangements are discussed presently).

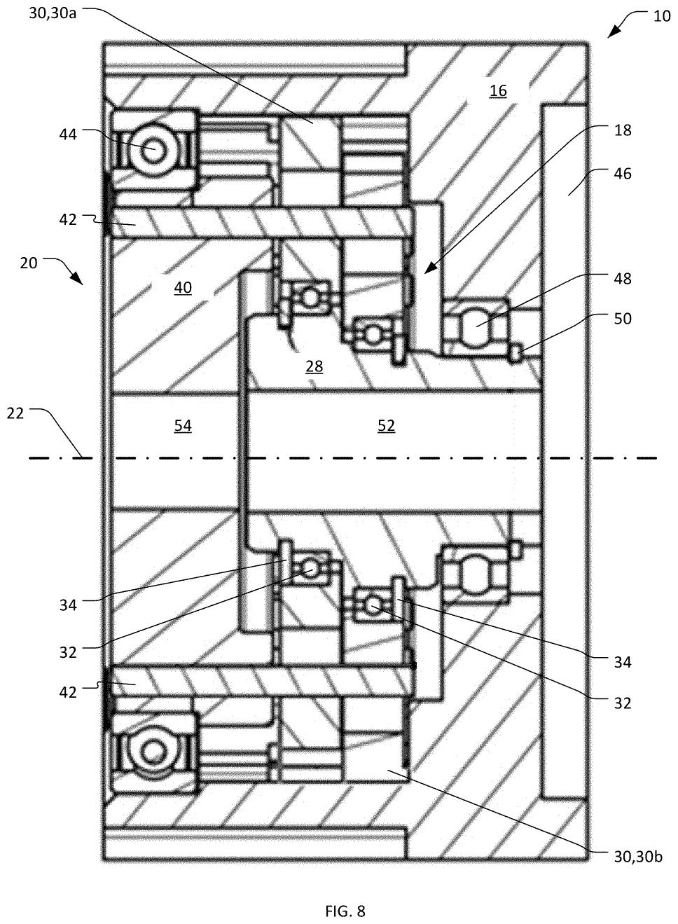

FIG. 7 is an exploded view of portions of the input rotor assembly 18 in FIG. 3. Here it can be seen that the input rotor assembly 18 includes an eccentric hub 28, a first cycloid disk 30a and a second cycloid disk 30b (collectively, cycloid disks 30), two lobe bearings 32, and two lobe bearing C-clips 34. Both of the cycloid disks 30 have sets of engagement holes 36.

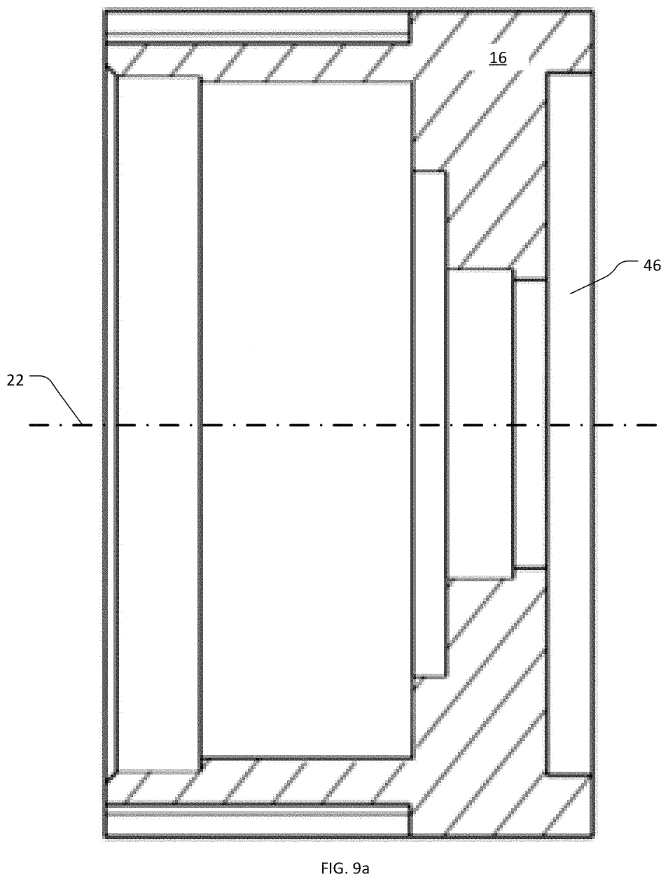

The eccentric hub 28 includes a first lobe 38a and a second lobe 38b (collectively lobes 38), which have an eccentric relationship in the conventional manner of all cycloidal speed reducers. The first lobe 38a mountably holds one lobe bearing 32 and thus the first cycloid disk 30a, and the second lobe 38b mountedly holds the other lobe bearing 32 and thus the second cycloid disk 30b. The two lobe bearing C-clips 34 attachably hold the lobe bearings 32 in place (and in turn each of their respective cycloid disks 30) onto the eccentric hub 28, thus making the input rotor assembly 18 an assembly. For completeness, the input rotor assembly 18 further includes an input bearing and an input bearing C-clip which are hidden from view here (see FIG. 8, discussed below).

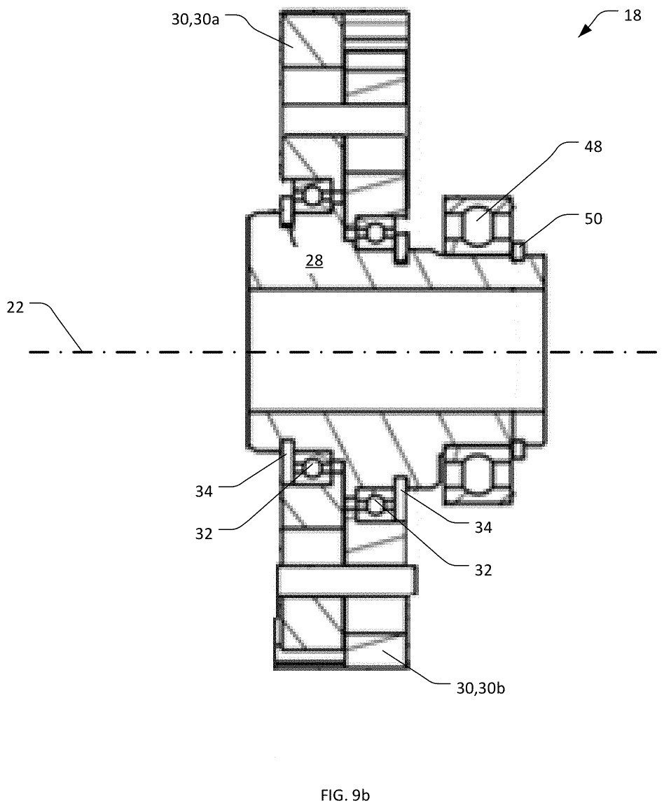

Returning to FIGS. 3 & 4, this also show the output rotor assembly 20. The output rotor assembly 20 includes a pin disc 40 holding or including a set of roller pins 42. The pin disc 40 is mountably held in an output bearing 44, and here it can again be seen how the retaining screws 24 (see also FIGS. 3, 4, and 5b) are able to holdably retain the output bearing 44 and thus the whole of the output rotor assembly 20 in the cycloidal speed reducer 10 when assembled. FIG. 9c, discussed presently, also shows considerable detail of just the output rotor assembly 20.

The role of the roller pins 42 in the output rotor assembly 20 is to rollingly engage with the sets of the engagement holes 36 in the cycloid disks 30 of the input rotor assembly 18. In this manner, as the drive motor 12 rotates the input rotor assembly 18 the output rotor assembly 20 is also rotated, albeit at a different speed as is the characteristic manner and benefit of cycloidal speed reducers.

FIG. 8 is a cross-sectional side plane view of the cycloidal speed reducer 10 taken along section A-A in FIG. 5b. Additional details of the housing 16, the input rotor assembly 18, and the output rotor assembly 20 can be seen here. FIGS. 9a-c show portions of FIG. 8, wherein FIG. 9a shows just the housing 16, FIG. 9b shows just the input rotor assembly 18, and FIG. 9c shows just the output rotor assembly 20.

Turning first to FIGS. 8 and 9a, it can be seen here that the housing 16 can be designed as needed to contain the input rotor assembly 18 and the output rotor assembly 20 within a cavity therein, as well as to facilitate use with various instances of the drive motor 12 and the driven device 14 as employed in general or particularized applications. For instance, the housing 16 here has a mating-face indent region 46 to facilitate flush mounting with the drive motor 12, if desired, say, to facilitate the goal of the cycloidal speed reducer 10 being, usable in compact overall applications.

Turning next to FIGS. 8 and 9b, it can particularly be seen here how the input rotor assembly 18 includes the eccentric hub 28, the cycloid disks 30, the lobe bearings 32, and the lobe bearing C-clips 34. Additionally shown here are the previously mentioned input bearing 48 and input bearing C-clip 50.

Turning next to FIGS. 8 and 9c, it can particularly be seen here how the output rotor assembly 20 includes the pin disc 40, the roller pins 42 (portions of two shown), and the output bearing 44.

Returning now to FIG. 8, all of the noted elements of FIGS. 9a-c are shown, albeit in a busier presentation. Additionally shown are how the eccentric hub 28 of the input rotor assembly 18 includes a drive input engagement feature 52, and how the pin disc 40 of the output rotor assembly 20 includes a drive output engagement feature 54.

Both the input engagement feature 52 and the output engagement feature 54 in this embodiment of the cycloidal speed reducer 10 are voids (i.e., female). That is, they are suitably shaped (albeit not necessarily same shaped) to receive male engaging features respectively of the drive motor 12 and the driven device 14. These voids are design features and not requirements of the inventive cycloidal speed reducer 10. However, since most conventional motors used in industry today have a male keyed shaft (e.g., as shown in the drive motor 12 in FIG. 3), embodiments of the cycloidal speed reducer 10 that have this “female input engagement option” (i.e., voids) will be useful in many applications.

While there is less “gender of engagement” standardization for driven devices, embodiments of the inventive cycloidal speed reducer 10 having a female or void for the output engagement feature 54 may still be flexibly employed (and stocked in fewer variations accordingly). For example, in the event that a given driven device also has a female engagement mechanism, such as a shaft-and-key shaped void to receive a conventional shaft and key, a simple, short length of shaft stock and key stock can be used to mate the cycloidal speed reducer 10 and the given driven device together.

Accordingly, in this manner embodiments of the cycloidal speed reducer 10 can be particularly employed where more compact overall applications are desired. Moreover, the inventive cycloidal speed reducer 10 can also have the housing 16 intentionally shaped to facilitate easy and standardized mating with conventional standardized shaped instances of drive motors and driven devices (e.g., as with the already discussed indent region 46 of the housing 16, and see general similarity of the shapes in FIG. 3).

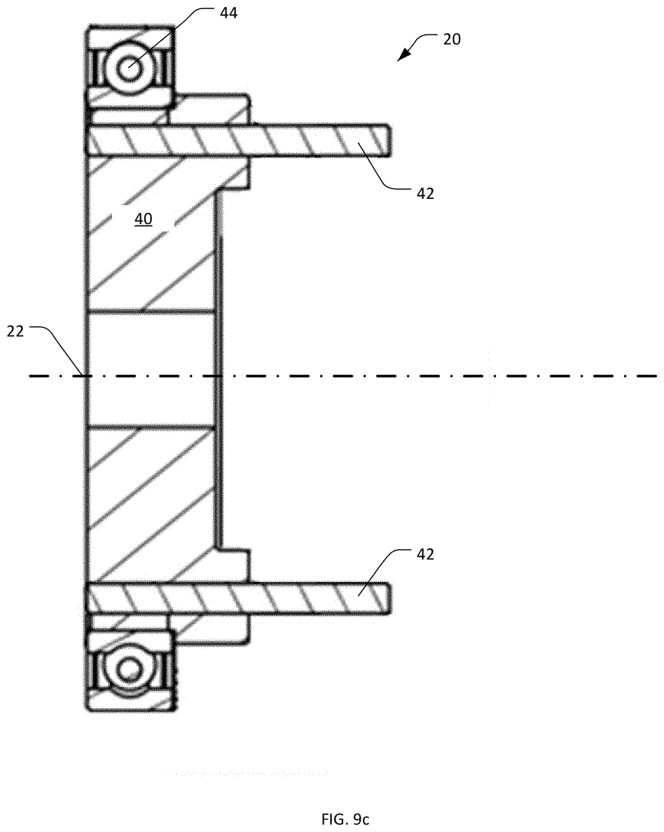

FIG. 10 is a highly stylized cross-sectional front plane view of the cycloidal speed reducer 10 taken along section B-B in FIG. 5c, wherein particular details of the stationary pin features 26 and of the cycloid disks 30 are visible.

It can again be seen here that the stationary pin features 26 need not be true “pins,” but rather that they can be integrated into the housing 16. Recall that roller pins are fixed (i.e., stationary; see e.g., FIGS. 1 and 2a (Prior Art)), and the discussion thereof, above). Accordingly, only a portion of a given roller pin is ever in contact with portions of a cycloidal disc or a cycloid. By integrating the stationary pin features 26 into the housing 16 (as semi-cylindrical protrusions), as shown in FIG. 10, the dimensions of the inventive cycloidal speed reducer 10 can be reduced, less materials used, fewer parts employed, replacements stocked, etc.

Next it can also be seen in FIG. 10 that the embodiment of the cycloidal speed reducer 10 here employs cycloid disks 30 having truncated-profile contact surfaces 56. To facilitate comparison FIG. 10 additionally shows the truncated-profile contact surfaces 56 of the front first cycloid disk 30a in solid lines overlayed with the contact surfaces of a conventional cycloidal device in ghost outline (dashed lines; again, compare this with the shape of the cycloidal disc 3 in the conventional cycloidal speed reducer 1 in FIG. 1 (Prior Art)).

Additionally, FIG. 10 shows that the eccentricity of the eccentric hub 28 can be equal to or greater than the radius of the stationary pin features 26, to increase the contact angle and thereby reduce friction. For example, the eccentricity can be 0.074 inches and the radius can be 0.068 inches

### Summarizing

The inventive cycloidal speed reducer 10 can have the truncated-profile contact surfaces 56, to reduce or eliminate sliding friction where the contact angle is smaller than would provide efficient torque transfer. This also can reduce the dimensions of embodiments.

The inventive cycloidal speed reducer 10 can have the stationary pin features 26 reduced to semicircular/semi-cylindrical protrusions from the housing 16, or be reduced from fully circular/cylindrical to semicircular/semi-cylindrical distinct elements. This can also reduce the dimensions of embodiments. Additionally, because of the high efficiency granted by other features of this invention, there is no need to add friction-reducing elements such as ball bearings to the roller pins 42. This can also reduce the dimensions and particularly the cost of embodiments.

The inventive cycloidal speed reducer 10 can have the eccentricity of the eccentric hub 28 be equal to or greater than the radius of the stationary pin features 26 to increase the contact angle and thereby reduce friction in embodiments.

The inventive cycloidal speed reducer 10 can have the input engagement feature 52 and/or the output engagement feature 54 be female voids. This eliminates the need for external shafts, couplings, etc. This also can reduce dimensions, as well as costs and provide yet other significant advantages in embodiments.

And the inventive cycloidal speed reducer 10 can have an exterior shape particularly similar and mate-able with similar or same cross-sectional dimensions likely in instances of the drive motor 12 and/or the driven device 14 (e.g., to conform with the 86 mm on a side industry standard for some common drive/driven devices).

While various embodiments have been described above, it should be understood that they have been presented by way of example only, and that the breadth and scope of the invention should not be limited by any of the above described exemplary embodiments but should instead be defined only in accordance with the following claims and their equivalents.

What is claimed is:

1. A cycloidal speed reducer mate-able between a drive motor (12) and an opposed driven device (14) along an axis of symmetry (22), the cycloidal speed reducer comprising:
a housing (16), an input rotor assembly (18), and an output rotor assembly (20);
said housing having a first end suitable for mating with the drive motor and a second end suitable for mating with the driven device, and further having a generally cylindrical shaped interior cavity located between said first end and said second end and coaxial with the axis of symmetry;
a plurality of stationary pin features (26) spaced equidistant apart around said interior cavity of said housing equidistant from the axis of symmetry, wherein said stationary pin features have a radius;
said input rotor assembly including an eccentric hub (28) having an eccentricity equal to or greater than said radius, a pair of lobes (38) each rotatably holding a cycloid disk (30), and having an input engagement feature (52) to engage with the drive motor, wherein said cycloid disks each have a plurality of engagement holes (36) and a plurality of contact surfaces (56) having truncated-profiles;
said output rotor assembly including a pin disc (40) holding a plurality of roller pins (42), and having an output engagement feature (54) to engage with the driven device; and
wherein as an input rotational motion is input to the cycloidal speed reducer from the drive motor, said input rotor assembly and said cycloid disks are rotated, said contact surfaces interact with said stationary pin features, said engagement holes of said cycloid disks interact with said roller pins of said output rotor assembly causing said output rotor assembly to be rotated, and an output rotational motion proportional to said input rotational motion is output to the driven device.

2. The cycloidal speed reducer of claim 1, wherein:
said first end of said housing includes an indent region suitable for mating a conventional instance of the drive motor.

3. The cycloidal speed reducer of claim 1, wherein:
said first end of said housing has same cross-sectional dimensions as a conventional instance of the drive motor.

4. The cycloidal speed reducer of claim 1, wherein:
said second end of said housing has same cross-sectional dimensions as a conventional instance of the driven device.

5. The cycloidal speed reducer of claim 1, wherein:
said input engagement feature is a female-like void suitable for accepting a male-like shaft of the drive motor.

6. The cycloidal speed reducer of claim 1, wherein:
said output engagement feature is a female-like void suitable for accepting a male-like shaft of the driven device.

7. The cycloidal speed reducer of claim 1, wherein:
said stationary pin features have semicircular cross-sections.

8. The cycloidal speed reducer of claim 7, wherein:
said stationary pin features are protrusions from said housing such that said housing and and said stationary pin features are a single unitary piece.

9. The cycloidal speed reducer of claim 7, wherein:
said stationary pin features are are distinct pieces seperable from said housing.

10. The cycloidal speed reducer of claim 1, wherein:
said engagement holes are 16 in quantity, said contact surfaces are 16 in quantity, and said stationary pin features are 17 in quantity.

11. The cycloidal speed reducer of claim 1, wherein:
said engagement holes have no friction-reducing elements where they with said roller pins and said roller pins have no friction-reducing elements where they mate with said pin disc.

12. A cycloidal speed reducer mate-able between a drive motor (12) and an opposed driven device (14) along an axis of symmetry (22), the cycloidal speed reducer comprising:
a housing (16), an input rotor assembly (18), and an output rotor assembly (20);
said housing having a first end suitable for mating with the drive motor and a second end suitable for mating with the driven device, and further having a generally cylindrical shaped interior cavity located between said first end and said second end and coaxial with the axis of symmetry;
a plurality of stationary pin features (26) spaced equidistant apart around said interior cavity of said housing equidistant from the axis of symmetry;
said input rotor assembly including an eccentric hub (28) having a pair of lobes (38) each rotatably holding a cycloid disk (30), and having an input engagement feature (52) that is a female-like void suitable for accepting a male-like shaft of the drive motor, wherein said cycloid disks each have a plurality of engagement holes (36) and a plurality of contact surfaces (56);
said output rotor assembly including a pin disc (40) holding a plurality of roller pins (42), and having an output engagement feature (54) that is a female-like void suitable for accepting a male-like shaft of the driven device; and
wherein as an input rotational motion is input to the cycloidal speed reducer from the drive motor, said input rotor assembly and said cycloid disks are rotated, said contact surfaces interact with said stationary pin features, said engagement holes of said cycloid disks interact with said roller pins of said output rotor assembly causing said output rotor assembly to be rotated, and an output rotational motion proportional to said input rotational motion is output to the driven device.

13. The cycloidal speed reducer of claim 1, wherein:
said first end of said housing includes an indent region suitable for mating a conventional instance of the drive motor.

14. The cycloidal speed reducer of claim 1, wherein:
said first end of said housing has same cross-sectional dimensions as a conventional instance of the drive motor.

15. The cycloidal speed reducer of claim 1, wherein:
said second end of said housing has same cross-sectional dimensions as a conventional instance of the driven device.

16. The cycloidal speed reducer of claim 1, wherein:
said stationary pin features have a radius and said eccentric hub has an eccentricity equal to or greater than said radius.

17. The cycloidal speed reducer of claim 1, wherein:
said contact surfaces have truncated-profiles.

18. The cycloidal speed reducer of claim 1, wherein:
said stationary pin features have semicircular cross-sections.

19. The cycloidal speed reducer of claim 18, wherein:
said stationary pin features are protrusions from said housing such that said housing and and said stationary pin features are a single unitary piece.

20. The cycloidal speed reducer of claim 18, wherein:
said stationary pin features are are distinct pieces seperable from said housing.

21. The cycloidal speed reducer of claim 1, wherein:
said engagement holes are 16 in quantity, said contact surfaces are 16 in quantity, and said stationary pin features are 17 in quantity.

22. The cycloidal speed reducer of claim 1, wherein:
said engagement holes have no friction-reducing elements where they with said roller pins and said roller pins have no friction-reducing elements where they mate with said pin disc.
